(19) United States
(12) Patent Application Publication
(10) Pub. No.: US 2008/0076889 A1
(43) Pub. Date: Mar. 27, 2008

(54) FILM FORMING COMPOSITION, FILM AND INSULATING FILM FORMED FROM THE COMPOSITION, AND ELECTRONIC DEVICE HAVING THE INSULATING FILM

(75) Inventor: Akira ASANO, Haibara-gun (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/859,884

(22) Filed: Sep. 24, 2007

(30) Foreign Application Priority Data
Sep. 27, 2006 (JP) 2006-263056

(51) Int. Cl. C08F 32/08

(52) U.S. Cl. 526/90

(57) ABSTRACT

A film forming composition includes a compound having a nanodisk structure.

### BACKGROUND OF THE INVENTION

1. Field of the Invention

The present invention relates to a film forming composition, more specifically, a film forming composition to be used for electronic devices and excellent in film properties such as dielectric constant, mechanical strength and heat resistance. Moreover, the invention relates to a film and insulating film available by using the composition and an electronic device having the insulating film.

2. Description of the Related Art

In recent years, with the progress of high integration, multifunction and high performance in the field of electronic materials, circuit resistance and condenser capacity between interconnects have increased and have caused an increase in electric power consumption and delay time. Particularly, the increase in delay time becomes a large factor for reducing the signal speed of devices and generating crosstalk. Reduction of parasitic resistance and parasitic capacity are therefore required in order to reduce this delay time, thereby attaining speed-up of devices. As one of the concrete measures for reducing this parasitic capacity, an attempt has been made to cover the periphery of an interconnect with a low dielectric interlayer insulating film. The interlayer insulating film is expected to have superior heat resistance in the thin film formation step when a printed circuit board is manufactured or in post steps such as chip connection and pin attachment and also chemical resistance in the wet process. In addition, a low resistance Cu interconnect has been introduced in recent years instead of an Al interconnect, and along with this, CMP (chemical mechanical polishing) has been employed commonly for planarization of the film surface. Accordingly, an insulating film having high mechanical strength and capable of withstanding this CMP step is required.

As a material of highly heat-resistant interlayer insulating films, polybenzoxazole, polyimide, polyarylene (ether) and the like have been disclosed for long years. There is however a demand for the development of materials having a lower dielectric constant in order to realize a high speed device. Introduction of a hetero atom such as oxygen, nitrogen or sulfur or an aromatic hydrocarbon unit into the molecule of a polymer as in the above-described materials, however, increases a dielectric constant owing to high molar polarization, causes a time-dependent increase in the dielectric constant owing to moisture absorption, or causes a trouble impairing reliability of an electronic device so that these materials need improvement.

A polymer composed of a saturated hydrocarbon has advantageously a lower dielectric constant because it has smaller molar polarization than a polymer composed of a hetero-atom-containing unit or aromatic hydrocarbon unit. For example, however, a hydrocarbon such as polyethylene having high flexibility has insufficient heat resistance and therefore cannot be used for electronic devices.

Polymers having, in the molecule thereof, a saturated hydrocarbon having a rigid cage structure such as adamantane or diamantane are disclosed (EP-1605016A2). Adamantane or diamantane is a preferable unit because it has a diamondoid structure and exhibits high heat resistance and low dielectric constant. As semiconductor devices become increasingly smaller, there is a constant demand for the development of an interlayer insulating film having a lower dielectric constant while minimizing a reduction in the mechanical strength.

### SUMMARY OF THE INVENTION

The present invention provides a film forming composition good in film properties such as dielectric constant, mechanical strength and heat resistance; a film and insulating film available by using the composition; and an electronic device having the insulating film. An “insulating film” is also referred to as a “dielectric film” or a “dielectric insulating film”, and these terms are not substantially distinguished.

The present inventors have found that the above-described problems can be overcome by the following constitutions <1>to <15>.

<1> A film forming composition comprising:

a compound having a nanodisk structure.

<2> The film forming composition as described in <1>, further comprising:

a thermosetting material.

<3> The film forming composition as described in <1>,

wherein the nanodisk structure comprises a polynuclear aromatic structure.

<4> The film forming composition as described in <2>,

wherein the thermosetting material comprises a compound having a cage structure.

<5> The film forming composition as described in <4>,

wherein the compound having a cage structure is a polymer of a monomer having a cage structure.

<6> The film forming composition as described in <5>,

wherein the monomer having a cage structure has a polymerizable carbon-carbon double bond or carbon-carbon triple bond.

<7> The film forming composition as described in <4>,

wherein the cage structure is selected from the group consisting of adamantane, biadamantane, diamantane, triamantane, tetramantane and dodecahedrane.

<8> The film forming composition as described in <5>,

wherein the monomer having a cage structure is selected from the group consisting of compounds represented by the following formulas (I) to (VI):

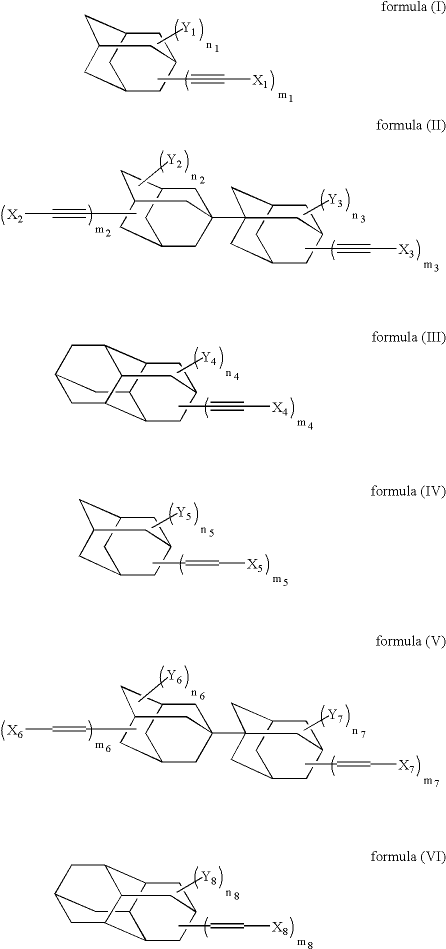

wherein X₁(s) to X₈(s) each independently represents a hydrogen atom, C₁₋₁₀ alkyl group, C₂₋₁₀ alkenyl group, C₂₋₁₀ alkynyl group, C₆₋₂₀ aryl group, C₀₋₂₀ silyl group, C₂₋₁₀ acyl group, C₂₋₁₀ alkoxycarbonyl group, or C₁₋₂₀ carbamoyl group,

Y₁(s) to Y₈(s) each independently represents a halogen atom, C₁₋₁₀ alkyl group, C₆₋₂₀ aryl group or C₀₋₂₀ silyl group,

m₁ and m₅ each independently represents an integer of from 1 to 16,

n₁ and n₅ each independently represents an integer of from 0 to 15,

m₂, m₃, m₆ and m₇ each independently represents an integer of from 1 to 15,

n₂, n₃, n₆ and n₇ each independently represents an integer of from 0 to 14,

m₄ and m₈ each independently represents an integer of from 1 to 20, and

n₄ and n₈ each independently stands for an integer of from 0 to 19.

<9> The film forming composition as described in <5>,

wherein the compound having a cage structure is obtained by polymerizing the monomer having a cage structure in the presence of a transition metal catalyst or a radical polymerization initiator.

<10> The film forming composition according claim <4>,

wherein the compound having a cage structure has a solubility at 25° C. of 3 mass % or greater in cyclohexanone or anisole.

<11> The film forming composition as described in <1>, further comprising:

an organic solvent.

<12> A film, which is formed by using the film forming composition as described in <1> and comprises the compound having a nanodisk structure.

<13> A film, which is formed by using the film forming composition as described in <4> and comprises the compound having a nanodisk structure and the compound having a cage structure.

<14> An insulating film formed by using the film forming composition as described in <1>.

<15> An electronic device comprising the insulating film as described in <14>.

### DETAILED DESCRIPTION OF THE INVENTION

The present invention will hereinafter be described specifically.

The term “compound having a nanodisk structure” as used herein means a compound having a planar structure as wide as about 0.5 to 1000 nm and having a thickness substantially as small as 10 or less atoms. In the invention, the nanodisk structure has a width, in the planar direction thereof, of preferably 10 nm or less, more preferably 5 nm or less, especially preferably 1 nm or less. It has a thickness of preferably 1 nm or less, more preferably 0.8 nm or less, especially preferably 0.7 nm or less.

Although elements constituting the nanodisk structure are not particularly limited, the nanodisk structure composed mainly of carbon, hydrogen, oxygen, nitrogen, and silicon having a relatively small atomic number is preferred from the standpoint of reducing a low dielectric constant. The nanodisk structure composed mainly of carbon, hydrogen, oxygen, and nitrogen and not containing silicon is more preferred. Specific examples of the compound having a nanodisk structure composed of carbon, hydrogen, oxygen and nitrogen include compounds of a colloid size having a polynuclear aromatic structure, which compounds have conventionally been proposed as an adsorbent for adsorbing thereto toxic substances in rivers. Such compounds are disclosed, for example, in Japanese Patent No. 3079260. Investigation of the detailed structure of these compounds having a polynuclear aromatic structure has revealed that they have a nanodisk structure (Carbon, 40, pp 1447-1445 (2002)). Since these compounds having a benzene-ring-like conjugated structure are likely to show electroconductivity, they are usually not employed as a constituent of an insulating film. As a result of the investigation by the present inventors, however, it has been found surprisingly that even a nanodisk structure having a conjugated structure can be employed for an insulating film and a low dielectric constant and high mechanical strength can be attained by the use of it. Use of a compound having such a structure in combination with a thermosetting material heightens this advantage further.

When a compound having a polynuclear aromatic compound is used in the invention, it has preferably at least one conjugated structure greater in an area occupied two-dimensionally by an electron cloud possessed by four benzene rings of pyrene adjacent to each other. It should be noted that in the invention, even conversion of some sp2 carbons forming the aromatic structure of a nanodisk structure into sp or sp3 carbon after curing of the thermosetting material.

Some examples of the compound having a nanodisk structure, which can be used in the invention, will next be described but the compound is not limited to these examples. The below-described compounds having a nanodisk structure may be subjected to, if necessary, chemical modification or linkage among a plurality of nanodisks.

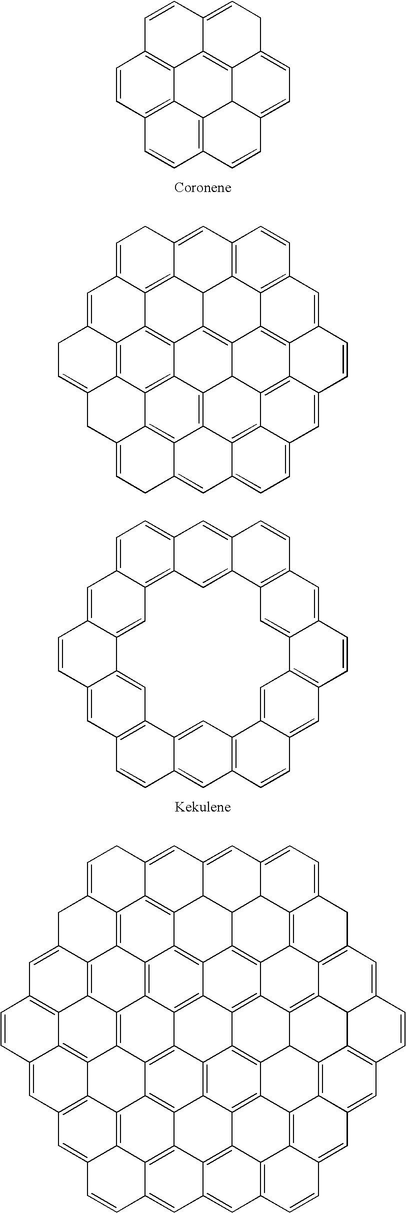

In the invention, compounds having the below-described structure or having the below-described structures connected to each other via a single bond are not embraced in the invention even if they have a plurality of aromatic structures, because aromatic structures are connected via a rotatable single bond, which may collapse the planar structure; and each resonance structure is judged equal to or narrower than the area of the resonance structure which pyrene has.

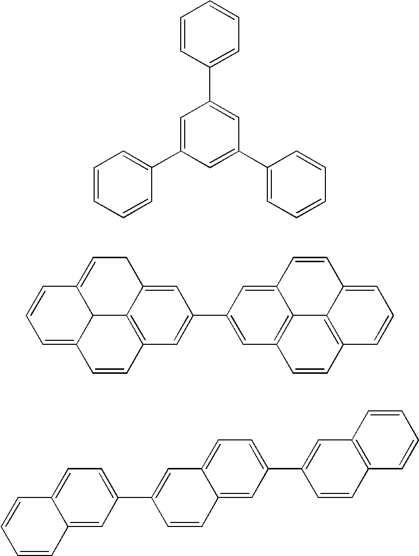

The compound having a nanodisk structure is added preferably in an amount of from 0.1 to 80 mass %, more preferably from 0.5 to 50 mass % relative to the solid component in the film forming composition.

As the thermosetting material, any conventionally known thermosetting polymer is usable without limitation, but organic polymers are preferred in consideration of their low dielectric constant and controllability of an etching rate during the fabrication of a semiconductor device. For example, organic polymers as disclosed in U.S. Pat. No. 6,646,081 and JP-A-2004-91543 (the term “JP-A” as used herein means an unexamined published Japanese patent application) are usable. Compounds having a cage structure, especially polymers of a monomer having a cage structure are preferred and materials as disclosed in JP-T-2004-504455 (the term “JP-T” as used herein means a published Japanese translation of a PCT patent application) or JP-A-2006-206857 are usable. In addition, it is most preferred that the number of aromatic structures in the polymer of the compound having a cage structure is as small as possible in consideration of a further reduction in the dielectric constant (Refer to EP-1605016A2).

The term “cage structure” as used herein means a molecule whose space is defined by a plurality of rings formed by covalent-bonded atoms and a point existing within the space cannot depart from the space without passing through these rings. For example, an adamantane structure may be considered as the cage structure. Contrary to this, a cyclic structure such as norbornane (bicyclo[2,2,1]heptane) having a single crosslink cannot be considered as the cage structure because the ring of the single-crosslinked cyclic compound does not define the space of the compound.

The cage structure of the invention may contain either a saturated bond or unsaturated bond and may contain a hetero atom such as oxygen, nitrogen or sulfur. A saturated hydrocarbon is however preferred from the viewpoint of a low dielectric constant.

Preferred examples of the cage structure of the invention include adamantane, biadamantane, diamantane, triamantane, tetramantane and dodecahedrane, of which adamantane, biadamantane and diamantane are more preferred. Of these, biadamantane and diamantane are especially preferred, because they have a low dielectric constant.

The cage structure according to the invention may have one or more substituents. Examples of the substituents include halogen atoms (fluorine, chlorine, bromine and iodine), linear, branched or cyclic C₁₋₁₀ alkyl groups (such as methyl, t-butyl, cyclopentyl and cyclohexyl), C₂₋₁₀ alkenyl groups (such as vinyl and propenyl), C₂₋₁₀ alkynyl groups (such as ethynyl and phenylethynyl), C₆₋₂₀ aryl groups (such as phenyl, 1-naphthyl and 2-naphthyl), C₂₋₁₀ acyl groups (such as benzoyl), C₂₋₁₀ alkoxycarbonyl groups (such as methoxycarbonyl), C₁₋₁₀ carbamoyl groups (such as N,N-diethylcarbamoyl), C₆₋₂₀ aryloxy groups (such as phenoxy), C₆₋₂₀ arylsulfonyl groups (such as phenylsulfonyl), nitro group, cyano group, and silyl groups (such as triethoxysilyl, methyldiethoxysilyl and trivinylsilyl).

In the invention, the cage structure is preferably divalent, trivalent or tetravalent. In this case, a group to be coupled to the cage structure may be a monovalent or higher valent substituent or a divalent or higher valent linking group. The cage structure is more preferably divalent or trivalent, especially preferably divalent.

The compound having a cage structure to be used in the invention is preferably a polymer of a monomer having a cage structure. The term “monomer” as used herein means a molecule which will be a dimer or higher polymer by the polymerization of the molecules. The polymer may either a homopolymer or copolymer.

The polymerization reaction of a monomer is caused by a polymerizable group substituted to the monomer. The term “polymerizable group” as used herein means a reactive substituent which causes polymerization of a monomer. Although any polymerization reaction can be employed, examples include radical polymerization, cationic polymerization, anionic polymerization, ring-opening polymerization, polycondensation, polyaddition, addition condensation and polymerization in the presence of a transition metal catalyst.

The polymerization reaction of a monomer in the invention is preferably carried out in the presence of a non-metallic polymerization initiator. For example, a monomer having a polymerizable carbon-carbon double bond or carbon-carbon triple bond can be polymerized in the presence of a polymerization initiator that generates free radicals such as carbon radicals or oxygen radicals by heating and thereby shows activity.

As the polymerization initiator, organic peroxides and organic azo compounds are preferred, of which organic peroxides are especially preferred.

Preferred examples of the organic peroxides include ketone peroxides such as “PERHEXA H”, peroxyketals such as “PERHEXA TMH”, hydroperoxides such as “PERBUTYL H-69”, dialkylperoxides such as “PERCUMYL D”, “PERBUTYL C” and “PERBUTYL D”, diacyl peroxides such as “NYPER BW”, peroxy esters such as “PERBUTYL Z” and “PERBUTYL L”, and peroxy dicarbonates such as “PEROYL TCP”, (each, trade name; commercially available from NOF Corporation).

Examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, and azoamidine compounds such as “V-50” and VA-057” (each, trade name; commercially available from Wako Pure Chemical Industries).

In the invention, these polymerization initiators may be used either singly or as a mixture.

The amount of the polymerization initiator in the invention is preferably from 0.001 to 2 moles, more preferably from 0.01 to 1 mole, especially preferably from 0.05 to 0.5 mole, per mole of a monomer.

In the invention, the polymerization reaction of a monomer may be effected preferably in the presence of a transition metal catalyst. For example, it is preferred to carry out polymerization of a monomer having a polymerizable carbon-carbon double bond or carbon-carbon triple bond, for example, in the presence of a Pd catalyst such as Pd(PPh₃)₄ or Pd(OAc)₂, a Ziegler-Natta catalyst, an Ni catalyst such as nickel acetyl acetonate, a W catalyst such as WCl₆, an Mo catalyst such as MoCl₅, a Ta catalyst such as TaCl₅, an Nb catalyst such as NbCl₅, an Rh catalyst or a Pt catalyst.

In the invention, these transition metal catalysts may be used either singly or as a mixture.

In the invention, the amount of the transition metal catalyst is preferably from 0.001 to 2 moles, more preferably from 0.01 to 1 mole, especially preferably from 0.05 to 0.5 mole per mole of the monomer.

The cage structure in the invention may have been substituted as a pendant group in the polymer or may have become a portion of the polymer main chain, but latter is preferred. When the cage structure has become a portion of the polymer main chain, the polymer chain is broken by the removal of the cage compound from the polymer. In this mode, the cage structure may be directly single-bonded or linked by an appropriate divalent linking group. Example of the linking group include —C(R₁)(R₁₂)—, —C(R₁₃)═C(R₁₄)—, —C≡C—, arylene group, —CO—, —O—, —SO₂—, —N(R₁₅)—, and —Si(R₁₆)(R₁₇)—, and combination thereof In these groups, R₁₁ to R₁₇ each independently represents a hydrogen atom, an alkyl group, an alkenyl group, an alkynyl group or an aryl group. These linking groups may be substituted by a substituent and the above-described substituents are preferably employed as it.

Of these, —C(R₁₁)(R₁₂)—, —CH═CH—, —C—C—, arylene group, —O— and —Si(R₁₆)(R₁₇)—, and combination thereof are more preferred, with —C(R₁₁)(R₁₂)— and —CH═CH— being especially preferred in consideration of a low dielectric constant.

The compound having a cage structure according to the invention may be either a low molecular compound or high molecular compound (for example, polymer), but is preferably a polymer. When the compound having a cage structure is a polymer, its weight average molecular weight is preferably from 1000 to 500000, more preferably from 5000 to 200000, especially preferably from 10000 to 100000. The polymer having a cage structure may be contained, as a resin composition having a molecular weight distribution, in a film forming composition. When the compound having a cage structure is a low molecular compound, its molecular weight is preferably from 150 to 3000, more preferably from 200 to 2000, especially preferably from 220 to 1000.

The compound having a cage structure according to the invention is preferably a polymer of a monomer having a polymerizable carbon-carbon double bond or carbon-carbon triple bond. The compound is more preferably a polymer of a compound represented by any one of the below-described formulas (I) to (VI).

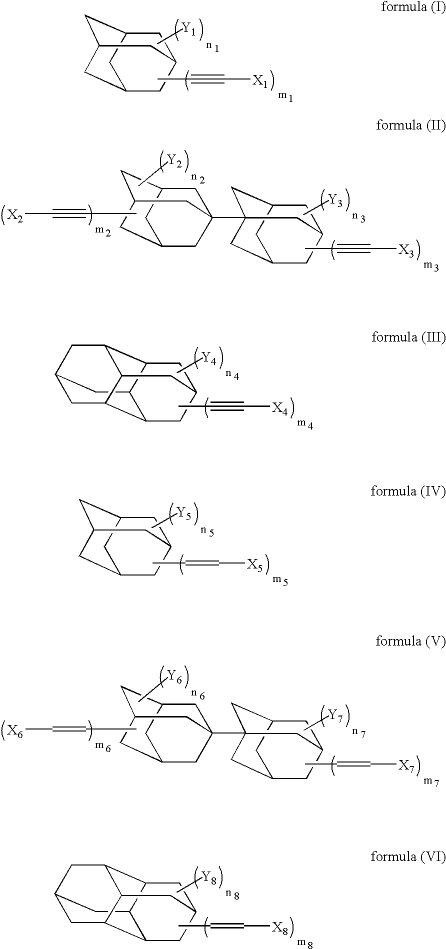

In the formulas (I) to (VI),

X₁(s) to X₈(s) each independently represents a hydrogen atom, a C₁₋₁₀ alkyl group, a C₂₋₁₀ alkenyl group, a C₂₋₁₀ alkynyl group, a C₆₋₂₀ aryl group, a C₀₋₂₀ silyl group, a C₂₋₁₀ acyl group, a C₂₋₁₀ alkoxycarbonyl group, or a C₁₋₂₀ carbamoyl group, of which hydrogen atom, C₁₋₁₀ alkyl group, C₆₋₂₀ aryl group, C₀₋₂₀ silyl group, C₂₋₁₀ acyl group, C₂₋₁₀ alkoxycarbonyl group, or C₁₋₂₀ carbamoyl group is preferred; hydrogen atom or C₆₋₂₀ aryl group is more preferred; and hydrogen atom is especially preferred.

Y₁(s) to Y₈(s) each independently represents a halogen atom (fluorine, chlorine, bromine or the like), a C₁₋₁₀ alkyl group, a C₆₋₂₀ aryl group, or a C₀₋₂₀ silyl group, of which a C₁₋₁₀ alkyl group or C₆₋₂₀ aryl group which may have a substituent is more preferred and an alkyl (methyl or the like) group is especially preferred.

X₁ to X₈ and Y₁ to Y₈ may each be substituted by another substituent.

In the above formulas,

m₁ and m₅ each independently stands for an integer from 1 to 16, preferably from 1 to 4, more preferably from 1 to 3, especially preferably 2;

n₁ and n₅ each independently stands for an integer from 0 to 15; preferably from 0 to 4, more preferably 0 or 1, especially preferably 0;

m₂, m₃, m₆ and m₇ each independently stands for an integer from 1 to 15; preferably from 1 to 4, more preferably from 1 to 3, especially preferably 2;

n₂, n₃, n₆ and n₇ each independently stands for an integer from 0 to 14; preferably from 0 to 4, more preferably 0 or 1, especially preferably 0;

m₄ and m₈ each independently stands for an integer from 1 to 20; preferably from 1 to 4, more preferably from 1 to 3, especially preferably 2; and

n₄ and n₈ each independently stands for an integer from 0 to 19, preferably from 0 to 4, more preferably 0 or 1, especially preferably 0.

The monomer having a cage structure according to the invention is preferably a compound represented by the above-described formula (II), (III), (V) or (VI), more preferably a compound represented by the formula (II) or (III), especially preferably a compound represented by the formula (III).

These compounds having a cage structure according to the invention may be used in combination. Two or more of the monomers having a cage structure according to the invention may be copolymerized.

The compounds having a cage structure according to the invention preferably have a sufficient solubility in an organic solvent. The solubility at 25° C. in cyclohexanone or anisole is preferably 3 mass % or greater, more preferably 5 mass % or greater, especially preferably 10 mass % or greater.

Examples of the compound having a cage structure according to the invention include polybenzoxazoles as described in JP-A-1999-322929, JP-A-2003-12802, and JP-A-2004-18593, quinoline resins as described in JP-A-2001-2899, polyaryl resins as described in JP-T-2003-530464, JP-T-2004-535497, JP-T-2004-504424, JP-T-2004-504455, JP-T-2005-501131, JP-T-2005-516382, JP-T-2005-514479, JP-T-2005-522528, JP-A-2000-100808 and U.S. Pat. No. 6,509,415, polyadamantanes as described in JP-A-1999-214382, JP-A-2001-332542, JP-A-2003-252982, JP-A-2003-292878, JP-A-2004-2787, JP-A-2004-67877 and JP-A-2004-59444, and polyimides as described in JP-A-2003-252992 and JP-A-2004-26850.

Specific examples of the monomer having a cage structure and usable in the invention include, but not limited to, the following ones.

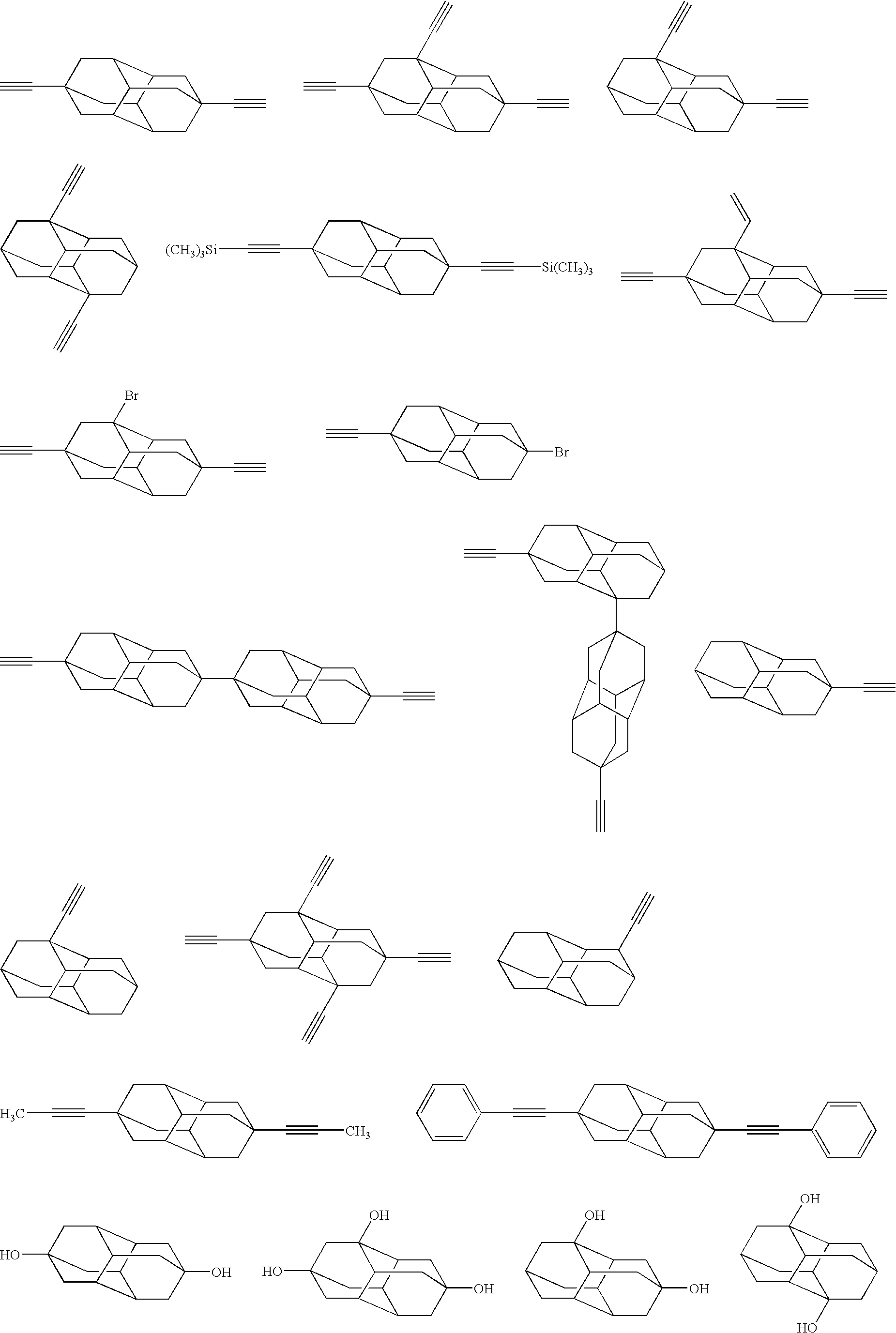

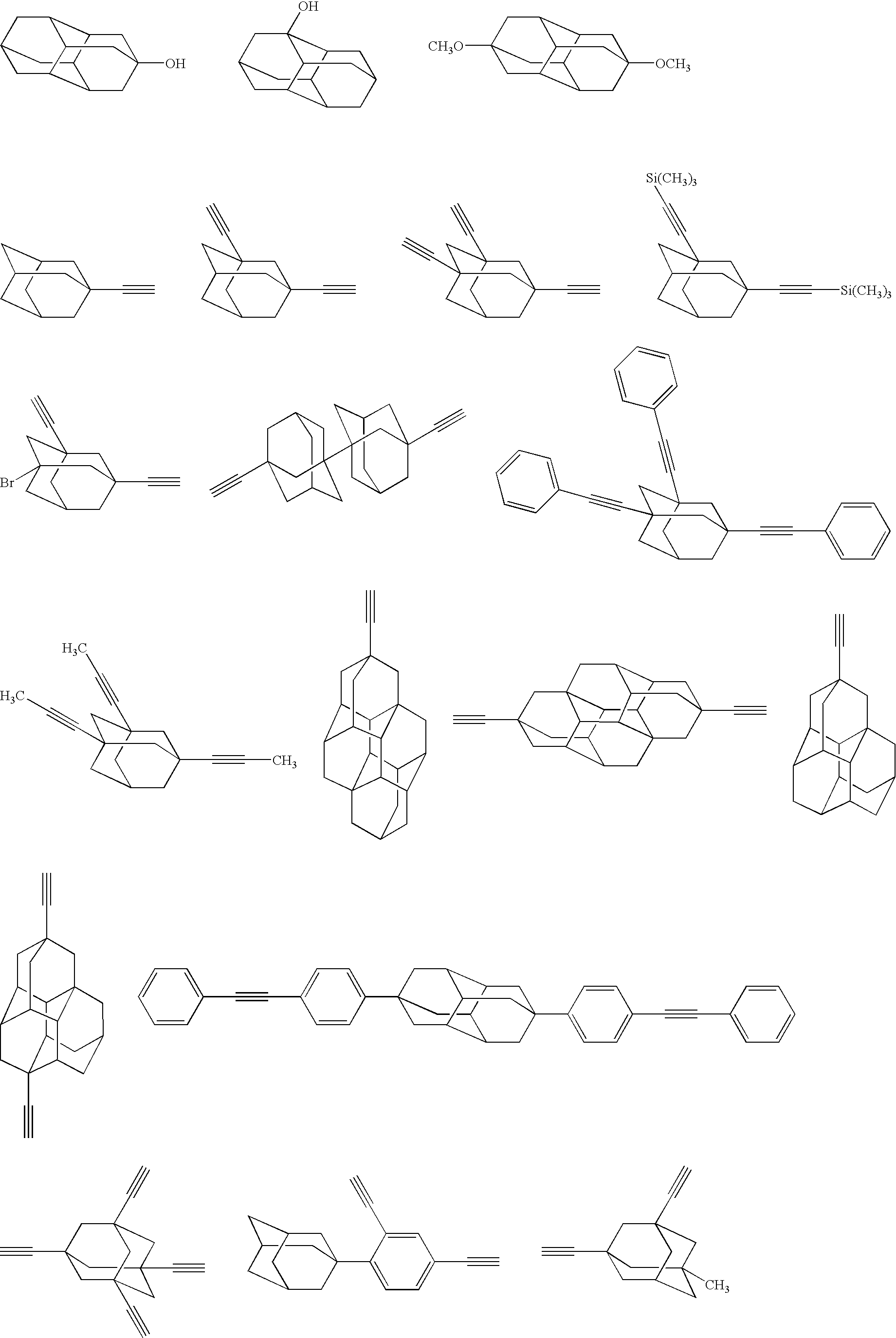

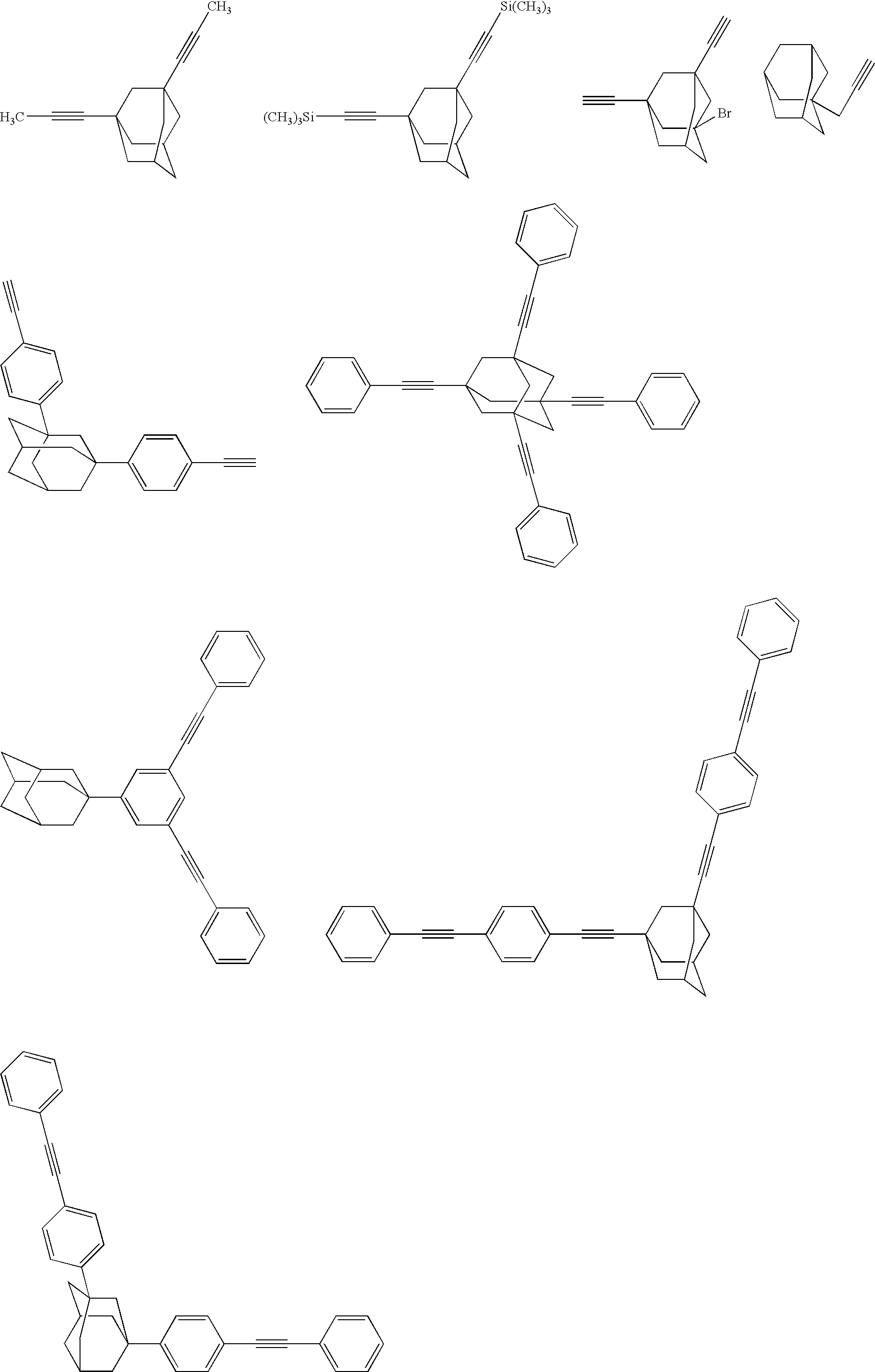

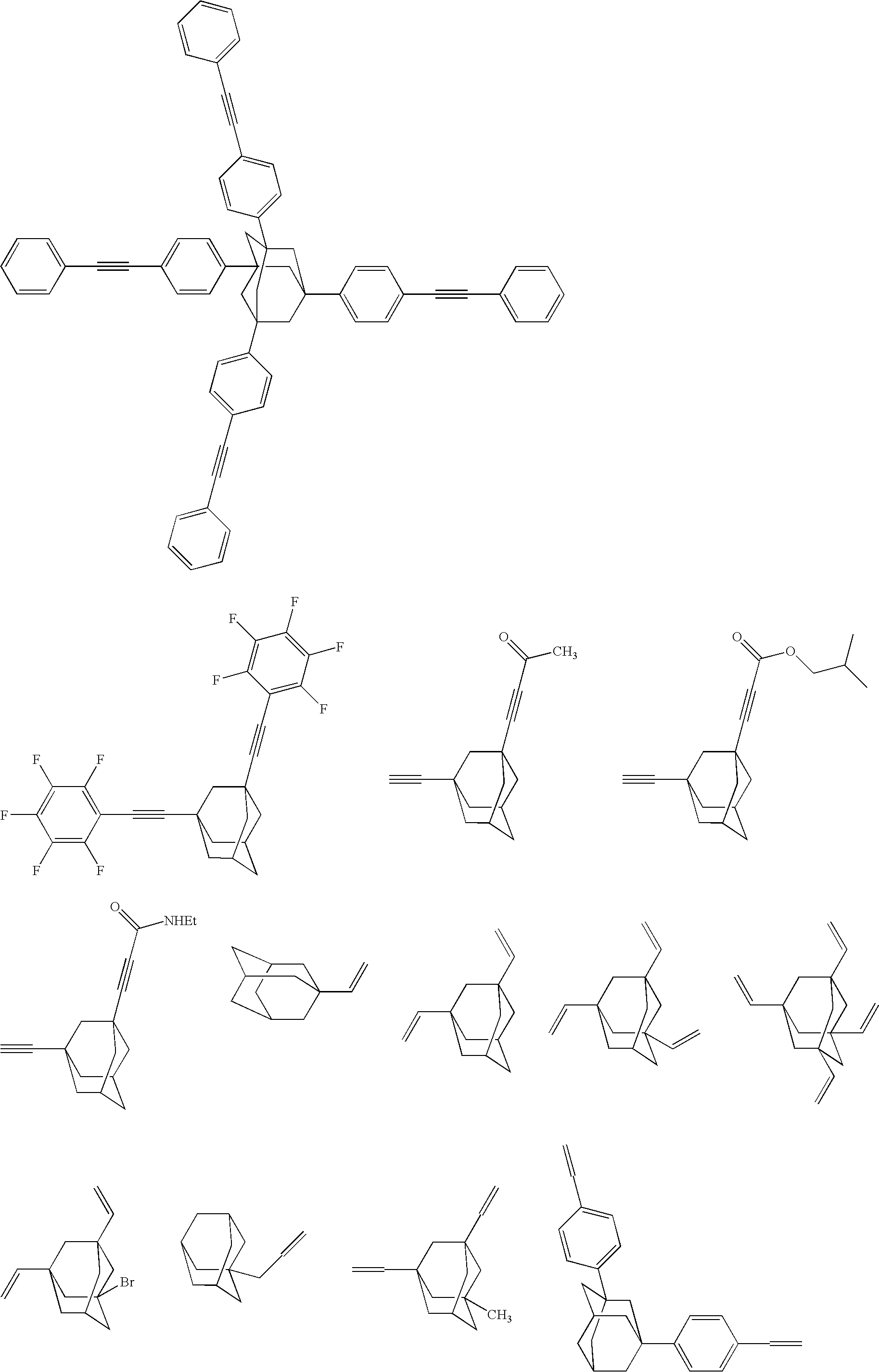

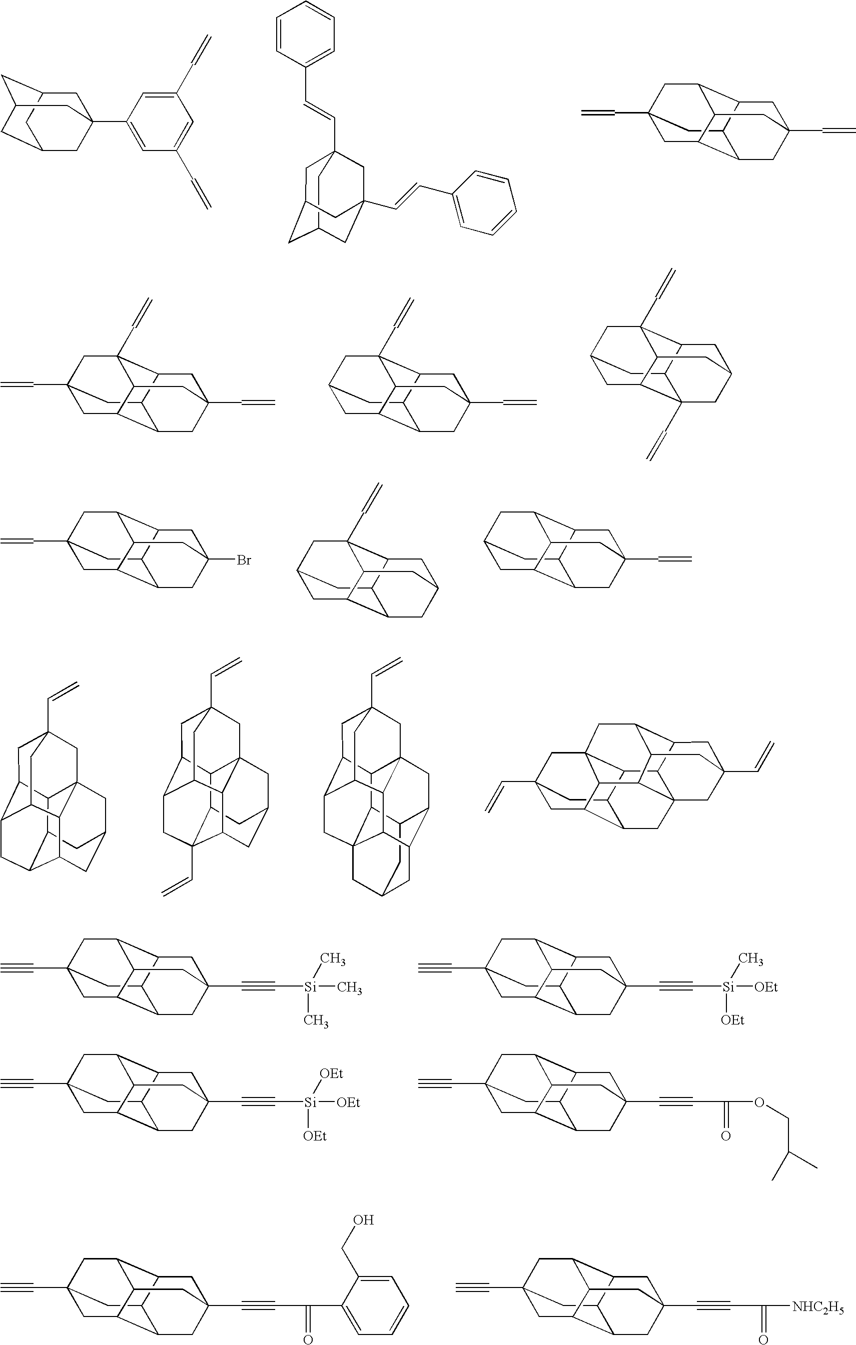

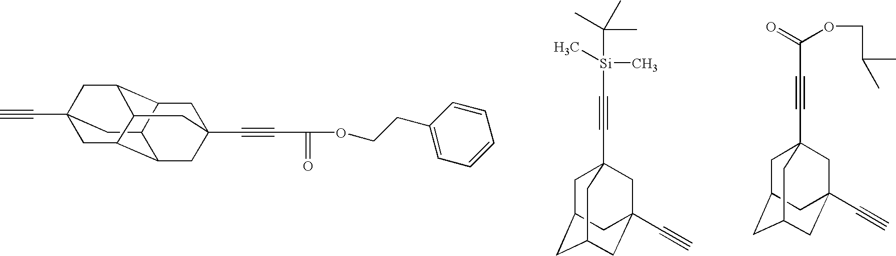

As the solvent used in the polymerization reaction, any solvent is usable insofar as it can dissolve a raw material monomer therein at a required concentration and has no adverse effect on the properties of a film formed from the polymer. Examples include water, alcohol solvents such as methanol, ethanol and propanol, ketone solvents such as alcohol acetone, methyl ethyl ketone, methyl isobutyl ketone, cyclohexanone and acetophenone; ester solvents such as ethyl acetate, butyl acetate, propylene glycol monomethyl ether acetate, γ-butyrolactone and methyl benzoate; ether solvents such as dibutyl ether and anisole; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene and 1,3,5-triisopropylbenzene; amide solvents such as N-methylpyrrolidinone and dimethylacetamide; halogen solvents such as carbon tetrachloride, dichloromethane, chloroform, 1,2-dichloroethane, chlorobenzene, 1,2-dichlorobenzene and 1,2,4-trichlorobenzene; and aliphatic hydrocarbon solvents such as hexane, heptane, octane and cyclohexane. Of these solvents, preferred are acetone, methyl ethyl ketone, methyl isobutyl ketone, cyclohexanone, acetophenone, ethyl acetate, propylene glycol monomethyl ether acetate, γ-butyrolactone, anisole, tetrahydrofuran, toluene, xylene, mesitylene, 1,2,4,5-tetramethylbenzene, isopropylbenzene, t-butylbenzene, 1,4-di-t-butylbenzene, 1,3,5-tri-t-butylbenzene, 4-t-butyl-orthoxylene, 1-methylnaphthalene, 1,3,5-triisopropylbenzene, 1,2-dichloroethane, chlorobenzene, 1,2-dichlorobenzene and 1,2,4-trichlorobenzene, of which tetrahydrofuran, γ-butyrolactone, anisole, toluene, xylene, mesitylene, isopropylbenzene, t-butylbenzene, 1,3,5-tri-t-butylbenzene, 1-methylnaphthalene, 1,3,5-triisopropylbenzene, 1,2-dichloroethane, chlorobenzene, 1,2-dichlorobenzene, and 1,2,4-trichlorobenzene are more preferred and γ-butyrolactone, anisole, mesitylene, t-butylbenzene, 1,3,5-triisopropylbenzene, 1,2-dichlorobenzene and 1,2,4-trichlorobenzene are especially preferred. These solvents may be used either singly or as a mixture.

The monomer concentration in the reaction mixture is preferably from 1 to 50 mass %, more preferably from 5 to 30 mass %, especially preferably from 10 to 20 mass %.

The conditions most suited for the polymerization reaction in the invention differ, depending on the kind or concentration of the polymerization initiator, monomer or solvent. The polymerization reaction is performed preferably at a bulk temperature of from 0 to 200° C., more preferably from 50 to 170° C., especially preferably from 100 to 150° C., preferably for 1 to 50 hours, more preferably from 2 to 20 hours, especially preferably from 3 to 10 hours.

To suppress the inactivation of the polymerization initiator which will otherwise occur by oxygen, the reaction is performed preferably in an inert gas atmosphere (for example, nitrogen or argon). The oxygen concentration upon reaction is preferably 100 ppm or less, more preferably 50 ppm or less, especially preferably 20 ppm or less.

The polymer obtained by polymerization has a weight average molecular weight of preferably from 1000 to 500000, more preferably from 5000 to 200000, especially preferably from 10000 to 100000.

The compound having a cage structure according to the invention can be synthesized, for example, by using commercially available diamantane as a raw material, reacting it with bromine in the presence or absence of an aluminum bromide catalyst to introduce a bromine atom into a desired position of it, causing a Friedel-Crafts reaction between the resulting compound with vinyl bromide in the presence of a Lewis acid such as aluminum bromide, aluminum chloride or iron chloride to introduce a 2,2-dibromoethyl group, and then converting it into an ethynyl group by HBr elimination using a strong base. More specifically, it can be synthesized in accordance with the process as described in Macromolecules, 24, 5266-5268 (1991) and 28, 5554-5560 (1995), Journal of Organic Chemistry, 39, 2995-3003 (1974) and the like.

An alkyl group or silyl group may be introduced by making the hydrogen atom of the terminal acetylene group anionic by using butyl lithium or the like and then reacting the resulting compound with an alkyl halide or silyl halide.

In the invention, the above-described polymers may be used either singly or as a mixture.

No particular limitation is imposed on the coating solvent to be used in the invention. Examples include alcohol solvents such as methanol, ethanol, 2-propanol, 1-butanol, 2-ethoxymethanol, 3-methoxypropanol and 1-methoxy-2-propanol; ketone solvents such as acetone, acetylacetone, methyl ethyl ketone, methyl isobutyl ketone, 2-pentanone, 3-pentanone, 2-heptanone, 3-heptanone, cyclopentanone and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether solvents such as diisopropyl ether, dibutyl ether, ethyl propyl ether, anisole, phenetole and veratrole; aromatic hydrocarbon solvents such as mesitylene, ethylbenzene, diethylbenzene, propylbenzene and t-butylbenzene; and amide solvents such as N-methylpyrrolidinone and dimethylacetamide. These solvents may be used either singly or in combination.

Of these, more preferred organic solvents are 1-methoxy-2-propanol, propanol, acetylacetone, cyclohexanone, propylene glycol monomethyl ether acetate, butyl acetate, methyl lactate, ethyl lactate, γ-butyrolactone, anisole, mesitylene, and t-butylbenzene, with 1-methoxy-2-propanol, cyclohexanone, propylene glycol monomethyl ether acetate, ethyl lactate, γ-butyrolactone, t-butylbenzene and anisole being especially preferred.

The solid concentration of the film forming composition of the invention is preferably from 1 to 50 mass %, more preferably from 2 to 15 mass %, especially preferably from 3 to 10 mass %.

The content of metals, as an impurity, of the film forming composition of the invention is preferably as small as possible. The metal content of the film forming composition can be measured with high sensitivity by the ICP-MS and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process decreases the dielectric constant of the film obtained by the invention. The metal content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis. When W ray is employed as an X-ray source, the metal concentrations of metal elements such as K, Ca, Ti, Cr, Mn, Fe, Co, Ni, Cu, Zn, and Pd can be measured. The concentrations of them are each preferably from 100×10¹⁰ atom·cm⁻² or less, more preferably 50×10¹⁰ atom·cm⁻² or less, especially preferably 10×10¹⁰ atom·cm⁻² or less. In addition, the concentration of Br as a halogen can be measured. Its remaining amount is preferably 10000×10¹⁰ atom·cm⁻² or less, more preferably 1000×10¹⁰ atom·cm⁻², especially preferably 400×10¹⁰ atom·cm⁻². Moreover, the concentration of Cl can also be observed as a halogen. In order to prevent it from damaging a CVD device, etching device or the like, its remaining amount is preferably 100×10¹⁰ atom·cm⁻² or less, more preferably 50×10¹⁰ atom·cm⁻², especially preferably 10×10¹⁰ atom·cm⁻².

To the film forming composition of the invention, additives such as radical generator, colloidal silica, surfactant, silane coupling agent and adhesive agent may be added without impairing the properties (such as heat resistance, dielectric constant, mechanical strength, coatability, and adhesion) of an insulating film obtained using it.

Any colloidal silica may be used in the invention. For example, a dispersion obtained by dispersing high-purity silicic anhydride in a hydrophilic organic solvent or water and having usually an average particle size of from 5 to 30 nm, preferably from 10 to 20 nm and a solid concentration of from about 5 to 40 mass % can be used.

Any surfactant may be added in the invention. Examples include nonionic surfactants, anionic surfactants and cationic surfactants. Further examples include silicone surfactants, fluorosurfactants, polyalkylene oxide surfactants, and acrylic surfactants. In the invention, these surfactants can be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably from 0.01 mass % or greater but not greater than 1 mass %, more preferably from 0.1 mass % or greater but not greater than 0.5 mass % based on the total amount of the film forming coating solution.

The term “silicone surfactant” as used herein means a surfactant containing at least one Si atom. Any silicone surfactant may be used in the invention, but it preferably has a structure containing an alkylene oxide and dimethylsiloxane, of which a silicone surfactant having a compound represented by the following chemical formula is more preferred:

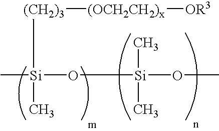

In the above formula, R represents a hydrogen atom or a C₁₋₅ alkyl group, x stands for an integer of from 1 to 20, and m and n each independently represents an integer of from 2 to 100. A plurality of R³s may be the same or different.

Examples of the silicone surfactant to be used in the invention include “BYK 306”, “BYK 307” (each, trade name; product of BYK Chemie), “SH7PA”, “SH21PA”, “SH28PA”, and “SH30PA” (each, trade name; product of Dow Coming Toray Silicone) and Troysol S366 (trade name; product of Troy Chemical).

As the nonionic surfactant to be used in the invention, any nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any fluorosurfactant is usable. Examples include perfluorooctyl polyethylene oxide, perfluorodecyl polyethylene oxide and perfluorododecyl polyethylene oxide.

As the acrylic surfactant to be used in the invention, any acrylic surfactant is usable. Examples include (meth)acrylic acid copolymer.

Any silane coupling agent may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-amino ethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. Those silane coupling agents may be used either singly or in combination. The silane coupling agent may be added preferably in an amount of 10 parts by weight or less, especially preferably from 0.05 to 5 parts by weight based on 100 parts by weight of the whole solid content.

In the invention, any adhesion accelerator may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate disopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion accelerator. The amount of the adhesion accelerator is preferably 10 parts by weight or less, especially preferably from 0.05 to 5 parts by weight, based on 100 parts by weight of the total solid content.

It is also possible to form a porous film by adding a pore forming factor to the extent permitted by the mechanical strength of the film and thereby reducing the dielectric constant of the film.

Although no particular limitation is imposed on the pore forming factor as an additive to serve as a pore forming agent, a non-metallic compound is preferred. The pore forming agent must satisfy both the solubility in a solvent to be used for a film forming coating solution and compatibility with the polymer of the invention. The boiling point or decomposition point of the pore forming agent is preferably from 100 to 500° C., more preferably from 200 to 450° C., especially preferably from 250 to 400° C. The molecular weight of it is preferably from 200 to 50000, more preferably from 300 to 10000, especially preferably from 400 to 5000. The amount of it in terms of mass % is preferably from 0.5 to 75%, more preferably from 0.5 to 30%, especially preferably from 1 to 20% relative to the polymer for forming a film. The polymer may contain a decomposable group as the pore forming factor. The decomposition point of it is preferably from 100 to 500° C., more preferably from 200 to 450° C., especially preferably from 250 to 400° C. The content of the decomposable group is, in terms of mole %, from 0.5 to 75%, more preferably from 0.5 to 30%, especially preferably from 1 to 20% relative to the monomer amount ofthe polymer for forming the film.

The film can be formed by applying the film forming composition of the invention onto a substrate by a desired method such as spin coating, roller coating, dip coating or scan coating, and then heating the substrate to remove the solvent. For drying off the solvent, the substrate is heated preferably for 0.1 to 10 minutes at from 40 to 250° C.

As the method of applying the composition to the substrate, spin coating and scan coating are preferred, with spin coating being especially preferred. For spin coating, commercially available apparatuses such as “Clean Track Series” (trade name; product of Tokyo Electron), “D-spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate.

When the solution of the composition is discharged, either dynamic discharge in which the solution is discharged onto a rotating substrate or static discharge in which the solution is discharged onto a static substrate may be employed. The dynamic discharge is however preferred in view of the in-plane uniformity of the film. Alternatively, from the viewpoint of reducing the consumption amount of the composition, a method of discharging only a main solvent of the composition to a substrate in advance to form a liquid film and then discharging the composition thereon can be employed. Although no particular limitation is imposed on the spin coating time, it is preferably within 180 seconds from the viewpoint of throughput. From the viewpoint of the transport of the substrate, it is preferred to subject the substrate to processing (such as edge rinse or back rinse) for preventing the film from remaining at the edge portion of the substrate. The heat treatment method is not particularly limited, but ordinarily employed methods such as hot plate heating, heating with a furnace, heating in an RTP (Rapid Thermal Processor) to expose the substrate to light of, for example, a xenon lamp can be employed. Of these, hot plate heating or heating with a furnace is preferred. As the hot plate, a commercially available one, for example, “Clean Track Series” (trade name; product of Tokyo Electron), “D-spin Series” (trade name; product of Dainippon Screen) and “SS series” or “CS series” (trade name; product of Tokyo Oka Kogyo) is preferred, while as the furnace, “a series” (trade name; product of Tokyo Electron) is preferred.

It is especially preferred to apply the polymer of the invention onto a substrate and then heating to cure it. For this purpose, the polymerization reaction, at the time of post heating, of a carbon-carbon double bond or a carbon-carbon triple bond remaining in the polymer may be utilized. The post heat treatment is performed preferably at from 100 to 450° C., more preferably at from 200 to 420° C., especially preferably at from 350 to 400° C., preferably for from 1 minute to 2 hours, more preferably for from 10 minutes to 1.5 hours, especially preferably for from 30 minutes to 1 hour. The post heat treatment may be performed in several times. This post heat treatment is performed especially preferably in a nitrogen atmosphere in order to prevent thermal oxidation due to oxygen.

In the invention, the polymer may be cured not by heat treatment but by exposure to high energy radiation to cause polymerization reaction of a carbon-carbon double bond or carbon-carbon triple bond remaining in the polymer. Examples of the high energy radiation include electron beam, ultraviolet ray and X ray. The curing method is not particularly limited to these methods.

When electron beam is employed as high energy radiation, the energy is preferably from 0 to 50 keV, more preferably from 0 to 30 keV, especially preferably from 0 to 20 keV Total dose of electron beam is preferably from 0 to 5 μC/cm² or less, more preferably from 0 to 2 μC/cm², especially preferably from 0 to 1 μC/cm² or less. The substrate temperature when it is exposed to electron beam is preferably from 0 to 450° C., more preferably from 0 to 400° C., especially preferably from 0 to 350° C. Pressure is preferably from 0 to 133 kPa, more preferably from 0 to 60 kPa, especially preferably from 0 to 20 kPa. The atmosphere around the substrate is preferably an atmosphere of an inert gas such as Ar, He or nitrogen from the viewpoint of preventing oxidation of the polymer of the invention. An oxygen, hydrocarbon or ammonia gas may be added for the purpose of causing reaction with plasma, electromagnetic wave or chemical species which is generated by the interaction with electron beam. In the invention, exposure to electron beam may be carried out in plural times. In this case, the exposure to electron beam is not necessarily carried out under the same conditions but the conditions may be changed every time.

Ultraviolet ray may be employed as high energy radiation. The radiation wavelength range of the ultraviolet ray is preferably from 190 to 400 nm, while its output immediately above the substrate is preferably from 0. 1 to 2000 mWcm⁻². The substrate temperature upon exposure to ultraviolet ray is preferably from 250 to 450° C., more preferably from 250 to 400° C., especially preferably from 250 to 350° C. The atmosphere around the substrate is preferably an atmosphere of an inert gas such as Ar, He or nitrogen from the viewpoint of preventing oxidation of the polymer of the invention. The pressure at this time is preferably from 0 to 133 kPa.

When the film obtained using the film forming composition of the invention is used as an interlayer insulating film for semiconductor, a barrier layer for preventing metal migration may be disposed on the side of an interconnect. In addition, a cap layer, an interlayer adhesion layer or etching stopping layer may be disposed on the upper or bottom surface of the interconnect or interlayer insulating film to prevent exfoliation at the time of CMP (Chemical Mechanical Polishing). Moreover, the layer of an interlayer insulating film may be composed of plural layers using another material as needed.

The film obtained using the film forming composition of the invention can be etched for copper interconnection or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, the ashing residue may be removed by washing.

The film obtained using the film forming composition of the invention may be subjected to CMP for planarizing the copper plated portion after copper interconnection. As a CMP slurry (chemical solution), a commercially available one (for example, product of Fujimi Incorporated, Rodel Nitta, JSR or Hitachi Chemical) can be used as needed. As a CMP apparatus, a commercially available one (for example, product of Applied Material or Ebara Corporation) can be used as needed. After CMP, the film can be washed in order to remove the slurry residue.

The film available using the film forming composition of the invention can be used for various purposes. For example, it is suited for use as an insulating film in semiconductor devices such as LSI, system LSI, DRAM, SDRAM, RDRAM and D-RDRAM, and in electronic devices such as multi-chip module multi-layered wiring board. It can also be used as a passivation film or an a-ray shielding film for LSI, a coverlay film for flexographic printing plate, an overcoat film, a cover coating for a flexible copper-clad board, a solder resist film, and a liquid crystal alignment film as well as an interlayer insulating film for semiconductor, an etching stopper film, a surface protective film, and a buffer coating film.

As another use, the film of the invention can be used as a conductive film after the film is doped with an electron donor or acceptor to make it conductive.

### EXAMPLES

The present invention will next be described by the following Examples, but the scope of it is not limited by them.

### Example 1

In accordance with the synthesis process as described in Macromolecules, 24, 5266 (1991), 4,9-diethynyldiamantane was synthesized. Under a nitrogen gas stream, 0.5 g of kekulene (containing 12 benzene-ring-like structures), 2 g of the resulting 4,9-diethynyldiamantane, 0.22 g of dicumyl peroxide (“PERCUMYL D”, trade name; product of NOF) and 10 ml of t-butylbenzene were polymerized by stirring for 7 hours at a bulk temperature of 150° C. After the reaction mixture was cooled to room temperature, 60 ml of isopropyl alcohol was added. The solid thus precipitated was collected by filtration and rinsed with isopropyl alcohol sufficiently. A coating solution was prepared by completely dissolving 1.0 g of the resulting polymer in 10 g of cyclohexanone. The resulting solution was filtered through a 0.1-μm filter made of tetrafluoroethylene, followed by spin coating on a silicon wafer. The coat thus obtained was heated at 200° C. for 60 seconds on a hot plate in a nitrogen gas stream to dry off the solvent and then baked for 60 minutes in an oven of 400° C. purged with nitrogen, whereby a 0.5-μm thick uniform film free from seeding was obtained. The specific dielectric constant of the film was calculated from the capacitance value at 1 MHz by using a mercury probe (product of Four Dimensions) and an LCR meter “HP4285A” (trade name; product of Yokogawa Hewlett-Packard). As a result, it was found to be 2.24. A Young's modulus of the film was measured using a nanoindenter SA-2 (product of MTS), resulting in 9.7 GPa.

### Comparative Example 1

In a similar manner to Example 1 except for the omission of kekulene, evaluation was made. As a result, the film thus obtained had a dielectric constant of 2.4 and Young's modulus of 8 Gpa.

### Comparative Example 2

In accordance with the synthesis process as described in Macromolecules, 24, 5266 (1991), 4,9-diethynyldiamantane was synthesized. Under a nitrogen gas stream, 0.5 g of pyrene (containing 4 benzene-ring-like structures), 2 g of the resulting 4,9-diethynyldiamantane, 0.22 g of dicumyl peroxide (“PERCUMYL D”, trade name; product of NOF) and 10 ml of t-butylbenzene were polymerized by stirring for 7 hours at a bulk temperature of 150° C. After the reaction mixture was cooled to room temperature, it was added to 60 ml of isopropyl alcohol. The solid thus precipitated was collected by filtration and rinsed with isopropyl alcohol sufficiently. A coating solution was prepared by completely dissolving 1.0 g of the resulting polymer in 10 g of cyclohexanone. The resulting solution was filtered through a 0.1-μm filter made of PTFE, followed by spin coating on a silicon wafer. The coat thus obtained was heated at 200° C. for 60 seconds on a hot plate in a nitrogen gas stream to dry off the solvent and then baked for 60 minutes in an oven of 400° C. purged with nitrogen, whereby a 0.5-μm thick uniform film free of seeding was obtained. The specific dielectric constant of the film was calculated from the capacitance value at 1 MHz by using a mercury probe (product of Four Dimensions) and an LCR meter “HP4285A” (trade name; product of Yokogawa Hewlett-Packard). As a result, it was found to be 2.41. A Young's modulus of the film was measured using a nanoindenter SA-2 (product of MTS), resulting in 7.8 GPa.

### Example 2

Referring to Japanese Patent No. 3079260 and Carbon 40, 1447-1455 (2002), a 1 mass % aqueous solution of a water soluble compound having a molecular weight of about 2500 and having a nanodisk structure was obtained. To the resulting aqueous solution was added propylene glycol monomethyl ether acetate (PGMEA) to adjust the concentration of the compound to about 0.5 mass %, whereby a nanodisk solution was obtained.

Under a nitrogen gas stream, 0.5 g of kekulene, 2 g of 4,9-diethynyldiamantane, 0.22 g of dicumyl peroxide (“PERCUMYL D”, trade name; product of NOF), 8 ml of t-butylbenzene and 2 ml of the nanodisk solution obtained above were polymerized by stirring for 7 hours at a bulk temperature of 150° C. After the reaction mixture was cooled to room temperature, 2 ml of the nanodisk solution and 0.2 g of dicumyl peroxide were added thereto again, followed by polymerization by stirring for 7 hours. After 60 ml of isopropyl alcohol was added, a solid thus precipitated was collected by filtration and rinsed with isopropyl alcohol sufficiently. A coating solution was prepared by completely dissolving 1.0 g of the resulting polymer in 10 g of cyclohexanone. The resulting solution was filtered through a 0.1-μm filter made of PTFE, followed by spin coating on a silicon wafer. The coat thus obtained was heated at 200° C. for 60 seconds on a hot plate in a nitrogen gas stream to dry off the solvent and then baked for 60 minutes in an oven of 400° C. purged with nitrogen, whereby a 0.5-μm thick uniform film free of seeding was obtained. The specific dielectric constant of the film was calculated from the capacitance value at 1 MHz by using a mercury probe (product of Four Dimensions) and an LCR meter “HP4285A” (trade name; product of Yokogawa Hewlett-Packard). As a result, it was found to be 2.18. A Young's modulus of the film was measured using a nanoindenter SA-2 (product of MTS), resulting in 11.2 GPa.

### Example 3

Referring to Japanese Patent No. 3079260 and Carbon 40, 1447-1455 (2002), a 1 mass % aqueous solution of a water soluble compound having a molecular weight of about 2500 and having a nanodisk structure was obtained. To the resulting aqueous solution was added propylene glycol monomethyl ether acetate (PGMEA) to adjust the concentration of the compound to about 0.5 mass %, whereby a nanodisk solution was obtained.

A coating solution was prepared with reference to EXAMPLE 3b in the specification of U.S. Pat. No. 6646081. The resulting coating solution (9.5 ml) was mixed with 0.5 ml of the nanodisk solution and the mixture was stirred at 32° C. for 47 hours.

The resulting solution was filtered successively through a 0.5-μm filter made of PTFE and a 0.1-μm filter made of tetrafluoroethylene and then spin-coated onto a silicon wafer. The coat thus obtained was heated at 200° C. for 60 seconds on a hot plate in a nitrogen gas stream to dry off the solvent and then baked for 60 minutes in an oven of 400° C. purged with nitrogen, whereby a 0.4-μm thick uniform film free from seeding was obtained. The specific dielectric constant of the film was calculated from the capacitance value at 1 MHz by using a mercury probe (product of Four Dimensions) and an LCR meter “HP4285A” (trade name; product of Yokogawa Hewlett-Packard). As a result, it was found to be 2.48. A Young's modulus of the film was measured using a nanoindenter SA-2 (product of MTS), resulting in 10.2 GPa.

The above-described results have revealed that films obtained in Examples have a Young's modulus of about 10 GPa and are thus superior in mechanical strength to the film obtained in Comparative Example, though they have a specific dielectric constant as low as less than 2.5.

According to the invention, a film forming composition good in film properties such as dielectric constant, mechanical strength and heat resistance; a film and insulating film available by using the composition; and an electronic device having the insulating film are provided.

The entire disclosure of each and every foreign patent application from which the benefit of foreign priority has been claimed in the present application is incorporated herein by reference, as if fully set forth.

What is claimed is:

1. A film forming composition comprising:
a compound having a nanodisk structure.

2. The film forming composition according to claim 1, further comprising:
a thermosetting material.

3. The film forming composition according to claim 1,
wherein the nanodisk structure comprises a polynuclear aromatic structure.

4. The film forming composition according to claim 2,
wherein the thermosetting material comprises a compound having a cage structure.

5. The film forming composition according to claim 4,
wherein the compound having a cage structure is a polymer of a monomer having a cage structure.

6. The film forming composition according to claim 5,
wherein the monomer having a cage structure has a polymerizable carbon-carbon double bond or carbon-carbon triple bond.

7. The film forming composition according to claim 4,
wherein the cage structure is selected from the group consisting of adamantane, biadamantane, diamantane, triamantane, tetramantane and dodecahedrane.

8. The film forming composition according to claim 5,
wherein the monomer having a cage structure is selected from the group consisting of compounds represented by the following formulas (I) to (VI): 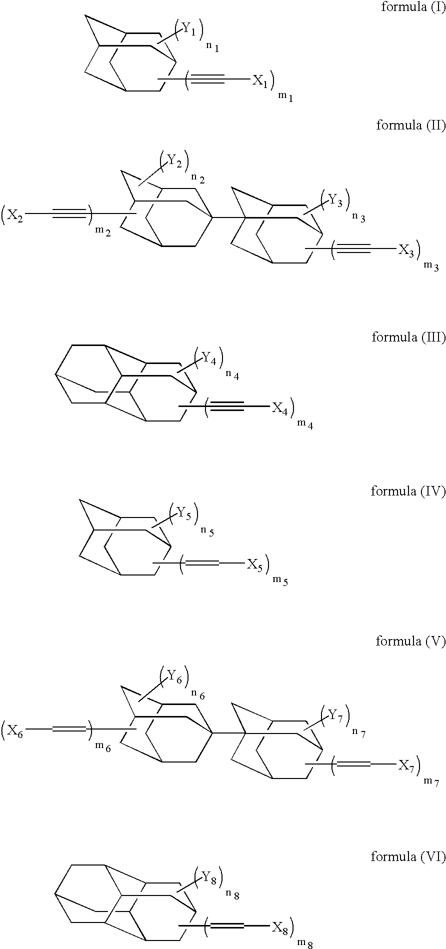
wherein X₁(s) to X₈(s) each independently represents a hydrogen atom, C₁₋₁₀ alkyl group, C₂₋₁₀ alkenyl group, C₂₋₁₀ alkynyl group, C₆₋₂₀ aryl group, C₀₋₂₀ silyl group, C₂₋₁₀ acyl group, C₂₋₁₀ alkoxycarbonyl group, or C₁₋₂₀ carbamoyl group,
Y₁(s) to Y₈(s) each independently represents a halogen atom, C₁₋₁₀ alkyl group, C₆₋₂₀ aryl group or C₀₋₂₀ silyl group,
m₁ and m₅ each independently represents an integer of from 1 to 16,
n₁ and n₅ each independently represents an integer of from 0 to 15,
m₂, m₃, m₆ and m₇ each independently represents an integer of from 1 to 15,
n₂, n₃, n₆ and n₇ each independently represents an integer of from 0 to 14,
m₄ and m₈ each independently represents an integer of from 1 to 20, and
n₄ and n₈ each independently stands for an integer of from 0 to 19.

9. The film forming composition according to claim 5,
wherein the compound having a cage structure is obtained by polymerizing the monomer having a cage structure in the presence of a transition metal catalyst or a radical polymerization initiator.

10. The film forming composition according claim 4,
wherein the compound having a cage structure has a solubility at 25° C. of 3 mass % or greater in cyclohexanone or anisole.

11. The film forming composition according to claim 1, further comprising:
an organic solvent.

12. A film, which is formed by using the film forming composition according to claim 1 and comprises the compound having a nanodisk structure.

13. A film, which is formed by using the film forming composition according to claim 4 and comprises the compound having a nanodisk structure and the compound having a cage structure.

14. An insulating film formed by using the film forming composition according to claim 1.

15. An electronic device comprising the insulating film according to claim 14.
